(19) United States
(12) Patent Application Publication
(10) Pub. No.: US 2025/0012979 A1
(43) Pub. Date: Jan. 9, 2025

(54) FIBER-OPTIC CABLE MAGNETIC COUPLING ADAPTER

(71) Applicant: UNIVERSITY INDUSTRY FOUNDATION, YONSEI UNIVERSITY WONJU CAMPUS, Wonju-si (KR)

(72) Inventors: Byung Jo JUNG, Wonju-si (KR); Dong Hwan KO, Wonju-si (KR); Su Bin PARK, Wonju-si (KR)

(21) Appl. No.: 18/894,010

(22) Filed: Sep. 24, 2024

Related U.S. Application Data
(63) Continuation of application No. PCT/KR2023/002620, filed on Feb. 23, 2023.

(30) Foreign Application Priority Data
Mar. 24, 2022 (KR) 10-2022-0036485

(51) Int. Cl. G02B 6/38

(52) U.S. Cl. CPC G02B 6/383; G02B 6/3886; G02B 6/3894

(57) ABSTRACT

The present invention relates to a fiber-optic cable magnetic coupling adapter, and the fiber-optic cable magnetic coupling adapter according to an embodiment of the present invention includes: an adapter main body; a joint that is provided on one surface of the adapter main body and has a magnetic body; and an insertion connection part that is provided on the other surface of the adapter main body and connected to a connector, in which the joint is provided as a protrusion that protrudes from a central portion of one surface of the adapter main body to an outer side of one surface, but has a hollow part formed inside and has opened one surface, or is provided as a recession that is recessed from the central portion of one surface of the adapter main body to an inner side of one surface, but is provided so as to be engaged with the protrusion and has the hollow part formed inside and has opened one surface.

### CROSS-REFERENCE TO RELATED APPLICATIONS

This application claims the priority of Korean Patent Application No. 10-2022-0036485 filed on Mar. 24, 2022 in the Korean Intellectual Property Office, the disclosure of which is incorporated herein by reference.

### BACKGROUND

### Field

The present invention relates to a fiber-optic cable magnetic coupling adapter.

### Description of the Related Art

The invasive procedures (e.g., invasive low-power laser treatment) using fiber-optic cables have a high probability of causing medical accidents due to the cables.

The unexpected situations (e.g., falling of a device main body or movement of a patient during treatment) that occurs during the invasive procedures may lead to medical accidents such as patients being dragged by devices connected to cables or treatment areas being strained.

The existing fiber-optic adapter has a structure that is not easily separated because it uses a screw or switch method to increase the optical transmission efficiency. As a result, when using the existing adapter, there is a problem that it is difficult to secure safety of medical staff and patients if it leads to a medical accident because the adapter is not easily separated even when a force is applied.

The background art of the present invention is disclosed in Japanese Patent Laid-Open Publication No. 2004-117581.

### SUMMARY

The present invention is intended to solve the problems of the above-mentioned conventional technology, and an object of the present invention provides a fiber-optic cable magnetic coupling adapter that can be attached and detached by magnetism and can be separated when a force exceeding a threshold is applied to prevent medical accidents.

However, the technical problems to be achieved by the embodiments of the present invention are not limited to the technical problems as described above, and other technical problems may exist.

As a technical means for achieving the above-mentioned technical task, a fiber-optic cable magnetic coupling adapter according to an embodiment of the present invention includes: an adapter main body; a joint that is provided on one surface of the adapter main body and has a magnetic body; and an insertion connection part that is provided on the other surface of the adapter main body and connected to a connector, in which the joint is provided as a protrusion that protrudes from a central portion of one surface of the adapter main body to an outer side of one surface, but has a hollow part formed inside and has opened one surface, or is provided as a recession that is recessed from the central portion of one surface of the adapter main body to an inner side of one surface, but is provided so as to be engaged with the protrusion and has the hollow part formed inside and has opened one surface.

In the adapter, when the joint is provided as the protrusion, the joint of the connection adapter connected to the adapter facing one surface may be provided as the recession, and when joint is provided as the recession, the joint of the connection adapter may be provided as the protrusion.

The adapter main body may include: a convex portion that protrudes from one surface of the adapter main body to an outer side of one surface; and a concave portion that is disposed at a gap from the convex portion and recessed into an inner side of the one surface, and the convex portion may be provided to be engaged with the concave portion of the connection adapter, and the concave portion may be provided to be engaged with the convex portion of the connection adapter.

The convex portion and the concave portion may be provided as magnetic bodies, and the convex portion and the concave portion may be provided to have different poles.

The adapter may further include a screw hole for fixing a position of the adapter with respect to a position between the convex portion and the concave portion on the adapter main body.

The adapter and the connection adapter may be connected with different types of connectors.

The means for solving the problem described above are merely exemplary and should not be construed as limiting the present invention. In addition to the exemplary embodiments described above, additional embodiments may exist in the drawings and detailed description of the present invention.

According to the above-described means for solving the problem of the present invention, since the joint of the adapter is provided with the magnetic body, the connection adapter can be easily detached from the joint of the connection adapters that are connected facing each other, so the safety of the patient and medical staff can be guaranteed from the risk that may occur due to the movement of the device body or the patient.

In addition, according to the above-described means for solving the problem of the present invention, since the joint is provided with the protrusion or the recession, it is possible to easily detach the connection adapter when connected to the joint of the connection adapter, but it is difficult to separate the connection adapter due to the force that moves to both sides, so that the separation of the adapter in the situation where the separation is unnecessary is prevented, thereby preventing the medical accidents.

In addition, according to the above-described means for solving the problem of the present invention, the adapter includes the convex portion and the concave portion, and the convex portion and the concave portion are provided as the magnetic body and thus are fixed as the magnetic body, so that the adapter does not move, thereby preventing the optical transmission efficiency from decreasing due to the movement of the cable during the medical treatment and preventing the medical accidents due to the movement of the adapter.

In addition, according to the above-described means of solving the problem of the present invention, since the joint, convex portion, and concave portion of the adapter are provided as the magnetic body, the additional fixing member is not required, so the connection can be made simpler.

In addition, according to the above-described means of solving the problem of the present invention, since the adapter includes the screw hole, the adapter can be used by being attached to the fixed location such as the device body, the bracket, or the like, if necessary.

In addition, according to the above-described means of solving the problem of the present invention, since the adapter and the connection adapter can be provided as different types of connectors, it is possible to couple between different types of connectors using various types of connectors.

However, the effects obtainable herein are not limited to the effects described above, and other effects may exist.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1A is a diagram for describing an implementation example in which a joint of a fiber-optic cable magnetic coupling adapter according to an embodiment of the present invention is a protrusion.

FIG. 1B is a diagram for describing an implementation example in which a joint of the fiber-optic cable magnetic coupling adapter according to an embodiment of the present invention is a recession.

FIG. 2A is a diagram for describing one implementation example of a main body of the fiber-optic cable magnetic coupling adapter according to an embodiment of the present invention.

FIG. 2B is a diagram for describing one implementation example of the main body of the fiber-optic cable magnetic coupling adapter according to an embodiment of the present invention.

FIG. 3 is a diagram for describing one implementation example of the fiber-optic cable magnetic coupling adapter according to an embodiment of the present invention.

FIG. 4 is a diagram for describing one implementation example of an engagement connection between the fiber-optic cable magnetic coupling adapter according to an embodiment of the present invention and a connection adapter.

FIG. 5A is a diagram for describing a convex portion and a concave portion of an implementation example in which the joint of the fiber-optic cable magnetic coupling adapter according to an embodiment of the present invention is a protrusion.

FIG. 5B is a diagram for describing the convex portion and concave portion of one implementation example in which the joint of the fiber-optic cable magnetic coupling adapter according to an embodiment of the present invention is a recession.

FIG. 6 is a diagram for describing an implementation example of an insertion connection part of the fiber-optic cable magnetic coupling adapter according to an embodiment of the present invention.

FIG. 7 is a diagram for describing an implementation example of using the fiber-optic cable magnetic coupling adapter according to an embodiment of the present invention that is attached to a bracket.

FIG. 8 is a diagram for describing an implementation example according to a connection method of connecting the fiber-optic cable magnetic coupling adapter according to an embodiment of the present invention and the connection adapter to a laser system.

FIG. 9 is a diagram for describing an implementation example according to a connection method for attaching the fiber-optic cable magnetic coupling adapter according to an embodiment of the present invention to the laser system.

### DETAILED DESCRIPTION OF THE EMBODIMENT

Hereinafter, exemplary embodiments of the present invention will be described in detail with reference to the accompanying drawings so that those skilled in the art to which the present invention pertains may easily practice. However, the present invention may be implemented in various different forms, and is not limited to the embodiments described herein. In addition, in the drawings, portions unrelated to the description will be omitted to clearly describe the present invention, and similar portions will be denoted by similar reference numerals throughout the specification.

Throughout the present specification, when any one part is referred to as being “connected to” another part, it means that any one part and another part are “directly connected to” each other or are “electrically connected to” each other with still another part interposed therebetween.

Throughout the present specification, when any member is referred to as being positioned “on”, “at upper portion”, “at upper end”, “below”, “at lower portion”, “at lower end” of another member, it includes not only a case in which any member and another member are in contact with each other, but also a case in which the other member is interposed between any member and another member.

Throughout the specification, “including” any component will be understood to imply the inclusion of other components rather than the exclusion of other components unless explicitly described to the contrary.

Hereinafter, a fiber-optic cable magnetic coupling adapter (hereinafter referred to as the “adapter”) according to one embodiment of the present invention will be described.

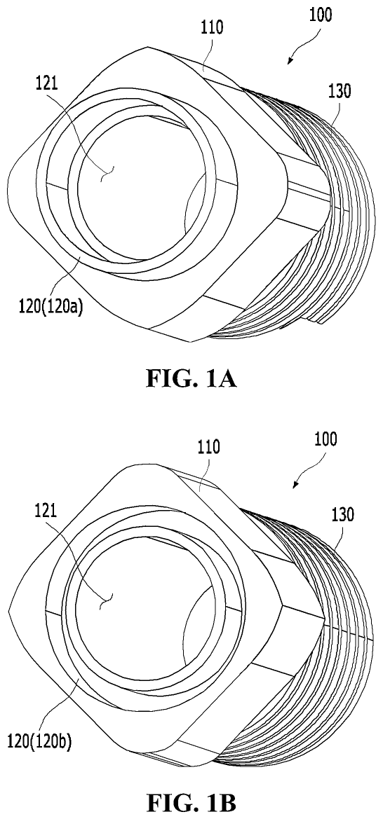

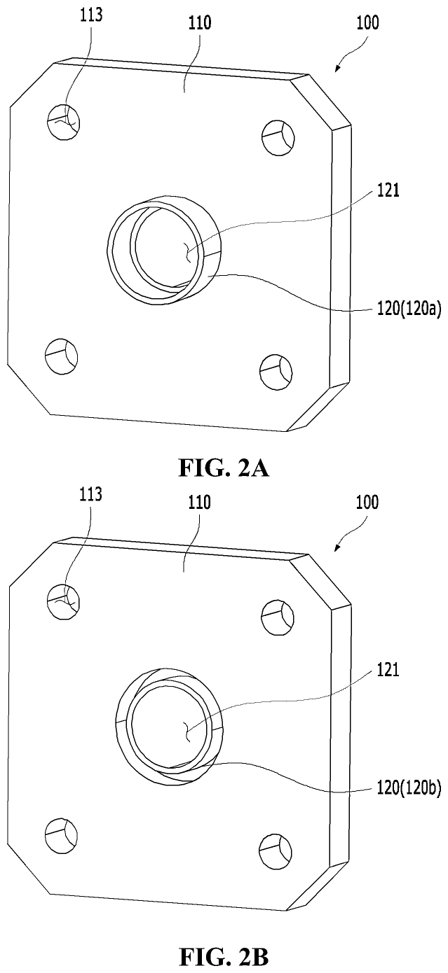

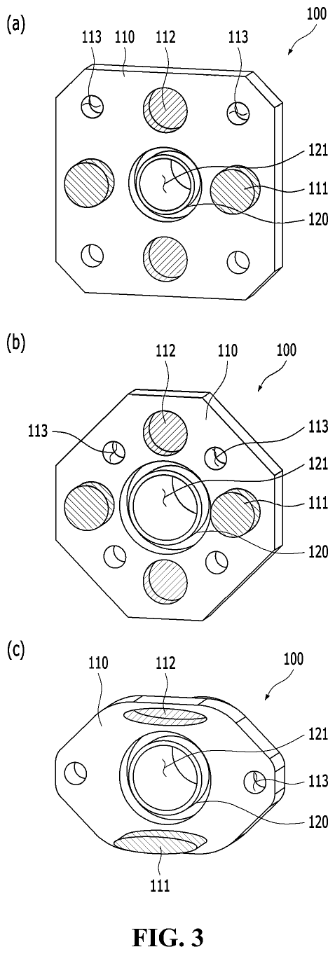

FIG. 1A is a diagram for describing an implementation example in which a joint of the fiber-optic cable magnetic coupling adapter according to an embodiment of the present invention is a protrusion, and FIG. 1B is a diagram for describing an implementation example in which the joint of the fiber-optic cable magnetic coupling adapter according to an embodiment of the present invention is a recession. In addition, FIG. 2A is a diagram for describing one implementation example of a main body of the fiber-optic cable magnetic coupling adapter according to an embodiment of the present invention, FIG. 2B is a diagram for describing one implementation example of the main body of the fiber-optic cable magnetic coupling adapter according to an embodiment of the present invention, and FIG. 3 is a diagram for describing one implementation example of the fiber-optic cable magnetic coupling adapter according to an embodiment of the present invention.

Referring to FIGS. 1A and 1B, the adapter 100 includes an adapter main body 110, a joint 120, and an insertion connection part 130. For example, the adapter 100 may be a small component used to connect fiber-optic cables or connectors.

For example, referring to FIGS. 1A to 3, the adapter main body 110 may be manufactured in various shapes such as a circle, a square, a hexagon, and a rhombus according to the usage environment, and thus may be widely used.

For example, referring to FIGS. 2A and 2B, the adapter main body 110 of the adapter 100 may be provided in a square shape.

Referring to FIGS. 1A and 1B, the joint 120 may be provided on one surface of the adapter main body 110 and provided to have a magnetic body. For example, referring to FIGS. 1A and 1B, one surface of the adapter main body 110 may be a surface facing an 8 o'clock side.

For example, the joint 120 may be provided to have a magnetic body so that it may be easily separated when a pulling force exceeds a certain level.

Referring to FIGS. 1A to 2B, the joint 120 may be provided as a protrusion 120a or a recession 120b.

Referring to FIGS. 1A and 2A, the protrusion 120a may protrude from a central portion of one surface of the adapter main body 110 to an outer side of one surface, and have a hollow part 121 formed inside and opened one surface.

For example, the protrusion 120a may protrude from a central portion of one surface of the adapter main body 110 to the outer side of one surface in a cylindrical shape with a circular cross section, but is not limited thereto.

In addition, for example, one surface of the protrusion 120a may be open, and the other surface thereof may also be open, so the protrusion 120a may be connected to an insertion connection part 130 to be described later.

In addition, for example, the protrusion 120a may be manufactured long to secure optical transmission efficiency.

Referring to FIGS. 1B and 2B, the recession 120b is provided to be recessed from the central portion of one surface of the adapter main body 110 to an inner side of one surface, but be engaged with the protrusion 120a, and may have a hollow part 121 formed inside and have opened one surface.

In addition, for example, referring to FIG. 1B, the recession 120b may be recessed from the central portion of one surface of the adapter main body 110 to the outer side of one surface in a cylindrical shape with a circular cross section, but is not limited thereto. In addition, for example, the recession 120b may be manufactured long to secure optical transmission efficiency.

In addition, for example, one surface of the recession 120b may be open, and the other surface thereof may also be open, so the recession 120b may be connected to the insertion connection part 130 to be described later.

In addition, for example, the protrusion 120a and the recession 120b may be manufactured to increase the optical transmission efficiency by coupling the existing components.

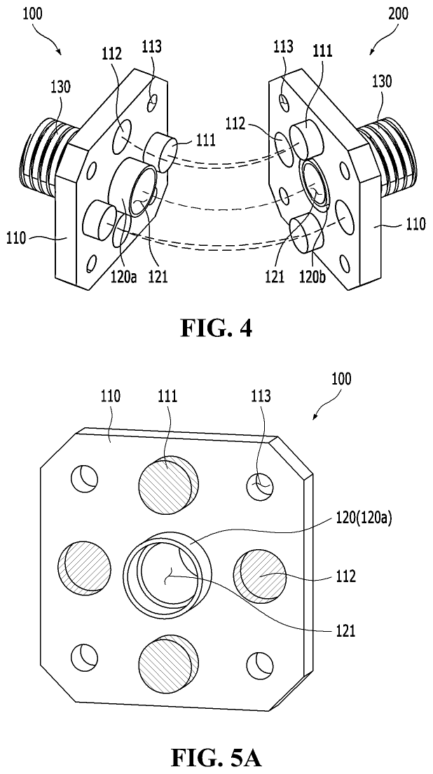

FIG. 4 is a diagram for describing one implementation example of an engagement connection between the fiber-optic cable magnetic coupling adapter according to an embodiment of the present invention and a connection adapter.

For example, referring to FIG. 4, when the adapter 100 is provided with the joint 120 as the protrusion 120a, the joint 120 of the connection adapter 200 connected to the adapter 100 facing one surface may be provided as the recession 120b. In addition, for example, when the adapter 100 is provided with the joint 120 as the recession 120b, the joint 120 of the connection adapter 200 connected to the adapter 100 facing one surface may be provided as the protrusion 120a.

For example, referring to FIG. 4, the adapter 100 and the connection adapter 200 are provided with opposite joints (for example, when the joint of the adapter is the protrusion, the joint of the connection adapter is provided as the recession, and when the joint of the adapter is the recession, the joint of the connection adapter is provided as the protrusion), so the joint 120 of the adapter 100 and the joint 120 of the connection adapter 200 may be connected to each other.

In addition, referring to FIGS. 1A, 1B, 2A, 2B, and 4, the joint 120 of the adapter 100 may be manufactured long to secure the optical transmission efficiency so that it is difficult to separate by a force moving to both sides and can be easily separated only by a pulling force. However, the joint 120 is not limited thereto, and as another example, the joint 120 of the adapter 100 may be manufactured short. For example, when the joint 120 of the adapter 100 is manufactured short, the connection of the joint can be separated by a force that moves to both sides, and thus, the connection of the joint may be easily separated even when a force occurs in the side (for example, in a 3 o'clock-9 o'clock direction based on FIG. 1A) in the unexpected situation, not just by the simple pulling force, thereby preventing the medical accidents.

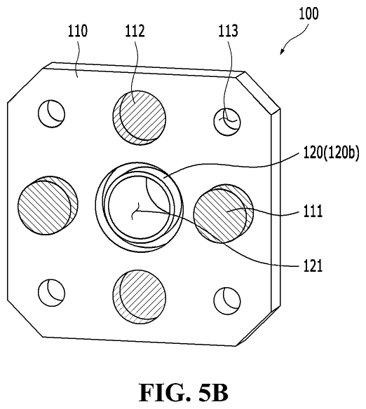

FIG. 5A is a diagram for describing a convex portion and a concave portion of an implementation example in which the joint of the fiber-optic cable magnetic coupling adapter according to an embodiment of the present invention is a protrusion, and FIG. 5B is a diagram for describing the convex portion and concave portion of one implementation example in which the joint of the fiber-optic cable magnetic coupling adapter according to an embodiment of the present invention is a recession.

Referring to FIGS. 4 to 5B, the adapter main body 110 may include a convex portion 111 and a concave portion 112.

Referring to FIGS. 5A and 5B, the convex portion 111 may protrude from one surface of the adapter main body 110 to the outer side of the one surface. For example, the convex portion 111 may be provided on the upper and lower sides of the joint 120, or may be provided on the left and right sides of the joint 120. However, the position of the convex portion 111 is not limited thereto.

For example, the convex portion 111 may protrude from one surface of the adapter main body (110) to the outer side of one surface in a shape with a circular cross section.

In addition, referring to FIGS. 5A and 5B, the concave portion 112 may be recessed from one surface of the adapter main body 110 to the inner side of one surface. For example, the concave portion 112 may be recessed from one surface of the adapter main body 110 to the inner side of one surface in a shape with a circular cross section. As another example, the concave portion 112 may be provided in an engageable shape corresponding to the shape of the convex portion 111.

In addition, referring to FIGS. 5A and 5B, the concave portion 112 may be disposed with a gap from the convex portion 111. For example, when the convex portion 111 is provided on the upper and lower sides of the joint 120, the concave portion 112 may be provided on the left and right sides of the joint 120. In addition, as another example, when the convex portion 111 is provided on the left and right sides of the joint 120, the concave portion 112 may be provided on the upper and lower sides of the joint 120.

Referring to FIG. 3, the convex portion 111 may be provided to be engaged with the concave portion 112 of the connection adapter 200. In addition, the concave portion 112 may be provided to be engaged with the convex portion 111 of the connection adapter 200.

For example, referring to FIG. 4, the convex portion 111 of the adapter 100 and the concave portion 112 of the connection adapter 200 may be positioned at a position where the engagement connection is possible, and may be provided in the engageable shape with each other. In addition, for example, referring to FIG. 4, the concave portion 112 of the adapter 100 and the convex portion 111 of the connection adapter 200 may be positioned at the position where the engagement connection is possible, and may be provided in the engageable shape with each other.

In addition, for example, the convex portion 111 and the concave portion 112 may prevent the adapter 100 and the connection adapter 200 from rotating or moving. Accordingly, the adapter 100 may be free from interference by the movement of the cable.

In addition, referring to FIGS. 4 to 5B, the convex portion 111 and the concave portion 112 may be provided as the magnetic bodies.

The convex portion 111 and the concave portion 112 may be provided to have different poles. For example, the convex portion 111 and the concave portion 112 may be provided as the magnetic bodies having different poles, so the adapter 100 and the connection adapter 200 may be more firmly connected.

For example, since the adapter 100 is provided as the magnetic body and may not be interfered by the movement of the cable, the interference factor is reduced, so that the adapter 100 can be firmly fixed with only the magnetic body of the joint 120 without having the convex portion 111 and the concave portion 112. However, the adapter 100 includes the convex portion 111 and the concave portion 112 and thus can be more firmly coupled.

In addition, the adapter 100 has the magnetic body, and thus can be easily attached and detached without additional procedures (e.g., screw, switch, male/female, etc.).

For example, the convex portion 111 and the concave portion 112 of the adapter 100 are provided to have the coupling structure corresponding to the concave portion 112 and the convex portion 111 of the connection adapter 200, and thus can be coupled, and may be provided so that they do not fall off due to the pushing force and are easily separated only when the pulling force is applied beyond the preset force.

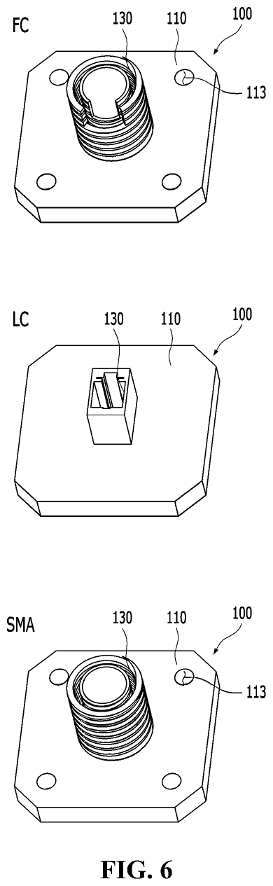

FIG. 6 is a diagram for describing an implementation example of an insertion connection part of the fiber-optic cable magnetic coupling adapter according to an embodiment of the present invention.

Referring to FIG. 6, the adapter 100 may include the insertion connection part 130. The insertion connection part 130 is provided on the other surface of the adapter main body 110 and may be connected to a connector. For example, referring to FIG. 1A, the other surface of the adapter main body 110 may be a surface facing a 2 o'clock side.

For example, referring to FIG. 6, the insertion connection part 130 may be connected to a FC type connector. In addition, for example, the insertion connection part 130 may be connected to an LC type connector. In addition, as another example, the insertion connection part 130 may be connected to an SMA type connector.

In addition, referring to FIGS. 4 and 6, the adapter 100 and the connection adapter 200 may be connected to different types of connectors. For example, the adapter 100 may be connected to the SMA type connector, and the connection adapter 200 may be connected to the FC type connector. In addition, as another example, the adapter 100 may be connected to the LC type connector, and the connection adapter 200 may be connected to the SMA type connector. Accordingly, the adapter 100 and the connection adapter 200 may be coupled to different types of connectors.

For example, since the adapter 100 has the magnetic body, the coupling between different types of connectors may be possible.

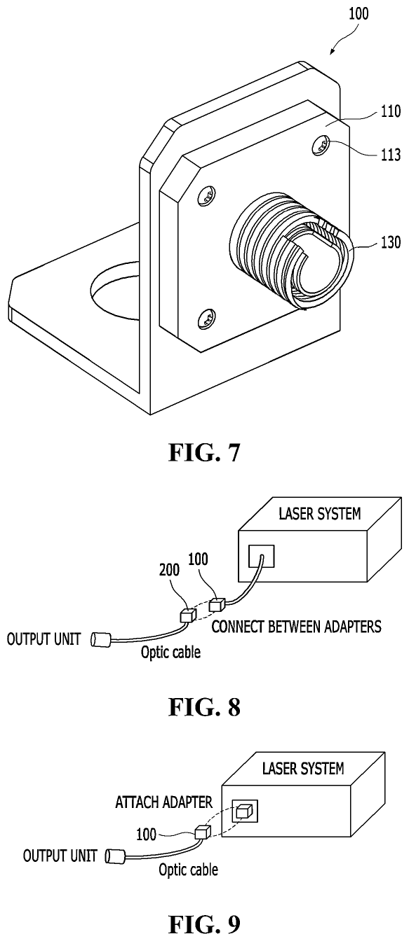

FIG. 7 is a diagram for describing an implementation example of using the fiber-optic cable magnetic coupling adapter according to an embodiment of the present invention that is attached to a bracket.

In addition, referring to FIGS. 2A to 7, the adapter 100 may include a screw hole 113. The screw hole 113 may be provided in order to fix the position of the adapter 100 with respect to the position between the convex portion 111 and the concave portion 112 of the adapter main body 110. For example, referring to FIG. 4A, the screw hole 113 may be positioned with respect to a 1-2 o'clock direction, a 4-5 o'clock direction, a 7-8 o'clock direction, and a 10-11 o'clock direction.

However, the position of the screw hole 113 is not limited thereto, and referring to FIGS. 2A and 2B, the screw hole 113 may also be provided in the adapter 100 that is not provided with the convex portion 111 and the concave portion 112, and thus, the screw hole 113 may be positioned with respect to the 1-2 o'clock direction, the 4-5 o'clock direction, the 7-8 o'clock direction, and the 10-11 o'clock direction.

For example, referring to FIG. 7, the screw hole 113 may be formed by processing the screw hole size to fit the standard, and a screw may be inserted into the screw hole 113, but is not limited thereto.

In addition, referring to FIG. 7, the adapter 100 may be easily attached to the device body, a fixed location, or a bracket by inserting the screw into the screw hole 113, and the adapter 100 may be used by being fixed to the device body, the fixed location, or the bracket.

In addition, referring to FIG. 7, the adapter 100 may be manufactured to the same standard as the conventional adapter, and thus can be used in a commercialized bracket. For example, in detail, referring to FIGS. 2A, 2B, and 7, when the adapter 100 is fixed to the bracket, the adapter 100 may be provided as the adapter 100 manufactured to the same standard as the conventional adapter that is not provided with the convex portion 111 or the concave portion 112. In addition, for example, more specifically, the adapter 100 fixed to the bracket may be the adapter 100 in which the joint 120 is provided as the recession 120b, and the adapter 100 in which the joint 120 of the adapter 100 is manufactured as the protrusion 120a may cause problems when mounted on the bracket.

However, the present invention is not limited thereto, and when there is no problem in focusing light to the center of the adapter 100, the adapter 100 provided with the convex portion 111 or the concave portion 112 may be fixed to the bracket, and fixed using a long screw.

In addition, for example, when conducting the experiments and treatments in the environment where the stability is guaranteed, the experiments and treatments may be performed by fixing the adapter 100 and the connection adapter 200 through the provided screw hole 113.

FIG. 8 is a diagram for describing an implementation example according to a connection method of connecting the fiber-optic cable magnetic coupling adapter according to an embodiment of the present invention and the connection adapter to a laser system, and FIG. 9 is a diagram for describing an implementation example according to a connection method for attaching the fiber-optic cable magnetic coupling adapter according to an embodiment of the present invention to the laser system.

For example, referring to FIGS. 8 and 9, the adapter 100 may be used by being connected to the laser system.

For example, referring to FIG. 8, the adapter 100 may be connected to the laser system by the cable, and may be connected to the connection adapter 200 to transmit the signal from the laser system to the output unit. In addition, as another example, referring to FIG. 9, the adapter 100 may be directly attached to the laser system and connected to the cable to transmit the signal to the output unit.

In addition, for example, the adapter 100 may be used regardless of whether or not there is a hole.

The above description of the present invention is for illustrative purposes, and those skilled in the art to which the present invention pertains will understand that it is possible to be easily modified to other specific forms without changing the technical spirit or essential features of the present invention. Therefore, it is to be understood that the exemplary embodiments described above are illustrative rather than being restrictive in all aspects. For example, each component described as a single type may be implemented in a distributed manner, and similarly, components described as distributed may be implemented in a combined form.

It is to be understood that the scope of the present invention will be defined by the claims rather than the above-mentioned description and all modifications and alternations derived from the claims and their equivalents are included in the scope of the present invention.

What is claimed is:

1. A fiber-optic cable magnetic coupling adapter, comprising:
an adapter main body;
a joint that is provided on one surface of the adapter main body and has a magnetic body; and
an insertion connection part that is provided on the other surface of the adapter main body and connected to a connector,
wherein the joint is provided as a protrusion that protrudes from a central portion of one surface of the adapter main body to an outer side of one surface, but has a hollow part formed inside and has opened one surface, or is provided as a recession that is recessed from the central portion of one surface of the adapter main body to an inner side of one surface, but is provided so as to be engaged with the protrusion and has the hollow part formed inside and has opened one surface.

2. The fiber-optic cable magnetic coupling adapter of claim 1, wherein, in the adapter, when the joint is provided as the protrusion, the joint of the connection adapter connected to the adapter facing one surface is provided as the recession, and
when the joint is provided as the recession, the joint of the connection adapter is provided as the protrusion.

3. The fiber-optic cable magnetic coupling adapter of claim 2, wherein the adapter main body includes:
a convex portion that protrudes from one surface of the adapter main body to an outer side of one surface; and
a concave portion that is disposed at a gap from the convex portion and recessed into an inner side of the one surface, and
the convex portion is provided to be engaged with the concave portion of the connection adapter, and
the concave portion is provided to be engaged with the convex portion of the connection adapter.

4. The fiber-optic cable magnetic coupling adapter of claim 3, wherein the convex portion and the concave portion are provided as magnetic bodies, and the convex portion and the concave portion are provided to have different poles.

5. The fiber-optic cable magnetic coupling adapter of claim 3, wherein the adapter further includes a screw hole for fixing a position of the adapter with respect to a position between the convex portion and the concave portion on the adapter main body.

6. The fiber-optic cable magnetic coupling adapter of claim 2, wherein the adapter and the connection adapter are connected with different types of connectors.
